(19) United States
(12) Patent Application Publication
(10) Pub. No.: US 2008/0019522 A1
(43) Pub. Date: Jan. 24, 2008

(54) Method For Managing A Communication Session in a Communication Network

(75) Inventor: Lee M. Proctor, Cary, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/425,495

(22) Filed: Jun. 21, 2006

(51) Int. Cl. H04K 1/00

(52) U.S. Cl. 380/255

(57) ABSTRACT

A method for managing a communication session between a first communication device and a second device in a communication network (100) is disclosed. The communication session is conveyed between a service-provider server and the first communication device via a first communication link. The method at the first communication device includes requesting (204) a third communication device to be associated with the communication session. The first communication device requests the third communication device, via a second communication link. The second communication link is substantially transparent to the service-provider server. The method also includes determining (206) whether the third communication device can be associated with the communication session. Further, the method includes requesting (208) the service-provider server to associate the communication session with the third communication device when the third communication session can be associated with the communication session, via a third communication link.

### FIELD OF THE INVENTION

This invention generally relates to communication networks, and more specifically, to a method for managing a communication session in a communication network.

### BACKGROUND OF THE INVENTION

Communication networks are becoming increasingly popular with an increase in the need for communication and information exchange. A communication network can include a plurality of communication devices and one or more service-provider servers. Some examples of communication networks include a computer network, the Internet, a public-switched telephone network, a code division multiple access (CDMA) network, and a global system for mobile communication (GSM) network. Some examples of communication devices include personal computers, mobile phones, laptops, and personal digital assistants (PDAs). Some examples of service-provider servers include web-based and mobile communication service-provider servers. The web-based service-provider server can receive a request from a communication device in a communication network and provide information related to the request. For example, a web server or a database server can receive a request from a mobile phone and provide information related to the request through the Internet. The mobile communication service-provider server can provide voice and data services to the plurality of communication devices in the communication network. A communication device in the communication network can request a service-provider server to hand off a communication session to another communication device. The communication device can hand off the communication session, for example, when its battery needs to be recharged, or a user wants to hand off the communication session from the communication device to a communication device associated with another user nearby. Similarly, the communication device can also add another communication device to the communication session, for example, to initiate a multi-party conference. Examples of the communication session include, but are not limited to, a voice call, a voice over Internet Protocol (IP) call, a push-to-talk session, a data session, an Internet session, a file download, a web-browsing session, a net-meeting session, a voice conference, and a video conference.

There is a technique for handing off a communication session and initiating a multi-party conference call. However, the technique requires that the communication session is placed on hold while it is handed off to the other communication device, or when the other communication device is added to it. When the communication session is placed on hold, the communication device is allowed to temporarily stop the communication session and subsequently resume it. Placing the communication session on hold can result in unnecessary delay in either handing off the communication session or adding the other communication device to it. Further, the existing technique requires either a pre-stored or manual entry of the identification of the other communication device, which can result in an overhead. Further, the manual entry may be a problem, especially when the communication device in the communication session is not aware of the identification of the other communication device. Moreover, initiation of the multi-party conference call or the communication session hand off requires substantial involvement of the service-provider server before another communication device can be involved in the multi-party conference call. This involvement of the service-provider server can also lead to an additional delay and messaging. Further, if the other communication device is unavailable, the service-provider sever would be needlessly involved.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary communication network, in accordance with one embodiment of the present invention;

FIG. 2 is a flow diagram illustrating a method for managing a communication session, in accordance with one embodiment of the present invention;

FIG. 3 is a message flow diagram illustrating a method for managing a communication session, in accordance with one embodiment of the present invention;

FIG. 4 is a flow diagram illustrating a method for managing a communication session, in accordance with another embodiment of the present invention;

FIG. 5 is a message flow diagram illustrating a method for managing a communication session, in accordance with another embodiment of the present invention;

FIG. 6 is a flow diagram illustrating a method for managing a communication session, in accordance with yet another embodiment of the present invention; and

FIG. 7 is a message flow diagram illustrating a method for managing a communication session, in accordance with yet another embodiment of the present invention.

### DETAILED DESCRIPTION

For one embodiment of the present invention, a method for managing a communication session between a first communication device and a second communication device in a communication network is provided. The communication network includes a plurality of communication devices and one or more service-provider servers. The communication session is conveyed between a service-provider server of the one or more service-provider servers and the first communication device, via a first communication link. The method at the first communication device includes requesting a third communication device of the plurality of communication devices to be associated with the communication session. The request is sent, via a second communication link. The second communication link is substantially transparent to the service-provider server. The method also includes determining whether the communication session can be associated with the third communication device. Moreover, the method includes requesting the service-provider server to associate the communication session with the third communication device when the communication session can be associated with the third communication device. The service-provider server associates the communication session with the third communication device, via a third communication link.

For another embodiment of the present invention, a method for managing a communication session between a first communication device and a second communication device in a communication network is provided. The communication network includes a plurality of communication devices and one or more service-provider servers. The communication session is conveyed between a service-provider server of the one or more service-provider servers and the first communication device, via a first communication link. The method at the third communication device includes requesting the first communication device to associate the third communication device with the communication session. The request is sent, via a second communication link, which is substantially transparent to the service-provider server. The method also includes determining whether the third communication device can be associated with the communication session. Further, the method includes requesting the service-provider server to associate the communication session with the third communication device when the third communication device can be associated with it. The service-provider server associates the communication session with the third communication device, via a third communication link.

For yet another embodiment of the present invention, a method for managing a communication session between a first communication device and a second communication device in a communication network is provided. The communication network includes a plurality of communication devices and one or more service-provider servers. The communication session is conveyed between a service-provider server of the one or more service-provider servers and the first communication device, via a first communication link. The method at the service-provider server includes receiving a request to associate a third communication device of the plurality of communication devices with the communication session. The first communication device communicates with the third communication device, via a second communication link. The second communication link is substantially transparent to the service-provider server. The method also includes determining whether the third communication device can be associated with the communication session. The method also includes associating the communication session with the third communication device, via a third communication link.

Before describing in detail the particular method for managing a communication session in a communication network, in accordance with various embodiment of the present invention, it should be observed that the present invention resides primarily in combinations of method steps related to the method for managing the communication session in the communication network. Accordingly, the method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element proceeded by “comprises . . . a” does not, without more constraints, preclude the existence of additional identical elements in the process, method, article, or apparatus that comprises the element.

The term “another,” as used in this document, is defined as at least a second or more. The term “includes” as used herein, are defined as comprising.

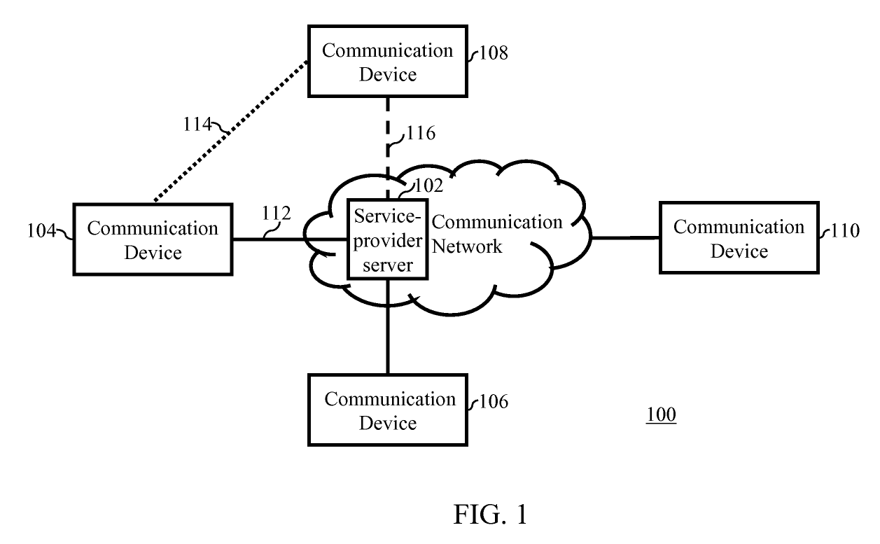

FIG. 1 illustrates an exemplary communication network 100, in accordance with one embodiment of the present invention. The communication network 100 can include one or more service-provider servers and a plurality of communication devices. Examples of the communication network 100 include, but are not limited to, an IEEE 802.16-based broadband wireless access network, an advanced mobile phone systems (AMPS) network, a global system for mobile communications (GSM) network, a digital cellular systems (DCS) network, a universal mobile telecommunication systems (UMTS) network, a Code Division Multiple Access (CDMA) network, and the Internet. For the purpose of this description, the communication network 100 is shown to include a service-provider server 102, a communication device 104, a communication device 106, a communication device 108, and a communication device 110. Examples of the service-provider server 102 include, but are not limited to, a web-based service-provider server and a mobile communication service-provider server. The web-based service-provider server can receive a request from a communication device in the communication network and provide information related to the request. For example, a web server or a database server can receive a request from a mobile phone and provide information related to the request through the Internet. The mobile communication service-provider server can provide voice and data services to the plurality of communication devices in the communication network. Examples of the communication devices 104, 106, 108 and 110 include, but are not limited to, cellular phones, laptop computers, personal digital assistants (PDAs), Internet Protocol (IP)-enabled phones, landline phones, voice-messaging systems, audio broadcast systems, video broadcast systems, portable gaming systems, and conferencing systems. The communication devices 104, 106, 108 and 110 can communicate, via communication links. For the purpose of this description, the service-provider server 102 and the communication device 104 are shown to communicate, via a communication link 112. Further, the communication device 104 can communicate with the communication device 108, via a short-range communication link and a short messaging service. Examples of the short-range communication link include, but are not limited to, an infrared communication link, a Universal Serial Bus (USB) communication link or other direct wired link, a Bluetooth™, and a Wireless Fidelity (WiFi) communication link. For the purpose of this description, the communication devices 104 and 108 are shown to communicate, via a short-range communication link, for example, a communication link 114. Further, a communication session between the communication devices 104 and 106 can be handed off to the communication device 108, via a communication link, for example, a communication link 116. Examples of the communication session include, but are not limited to, a voice call, a voice over Internet Protocol (IP)-call, a push-to-talk session, a data session, an Internet session, a file download, a web-browsing session, a net-meeting session, a dispatch group session, a voice conference, and a video conference. Further, information about the communication session could be conveyed from the communication device 104 to the communication device 108. Examples of the information about the communication session that could be conveyed between the communication devices 104 and 108 include, but are not limited to, a caller number and a universal resource locator (URL). For one embodiment, the information about the communication session could also be conveyed to assist with a subsequent reception, decoding, and participation in the communication session. Examples of the information about the communication session include, but are not limited to, a position in a file, a web page number, a position in a video stream, a data rate of the communication session, an encoding rate of the communication session, a decoder state, object information, a game scenario being played, and a characteristic of a game. For one embodiment, the communication device 108 can join the communication session between the communication devices 104 and 106, via a communication link 116.

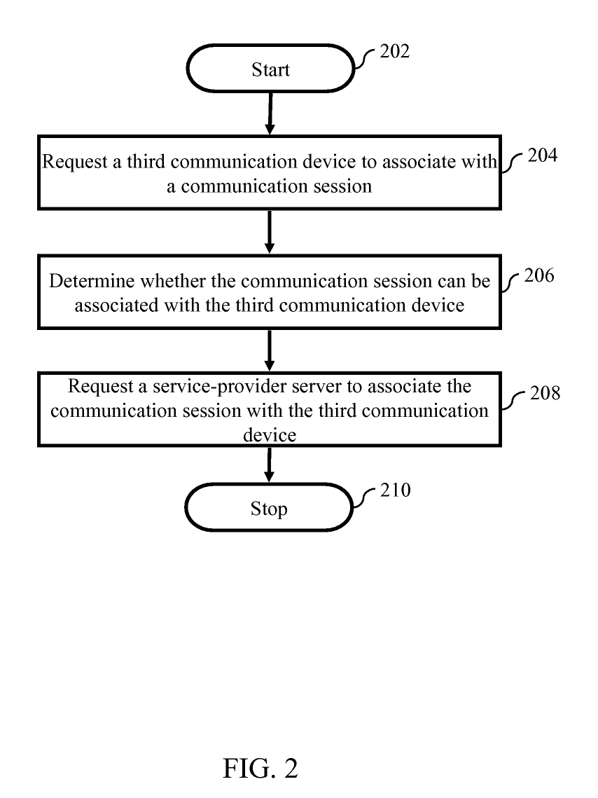

FIG. 2 is a flow diagram illustrating a method for managing a communication session, in accordance with one embodiment of the present invention. The communication session is managed between a first communication device and a second communication device. Examples of the first and the second communication device include, but are not limited to, mobile phones, landline phones and computers. The communication session between the first communication device and the service-provider server can be conveyed, via a first communication link. For example, the communication session between the service-provider server 102 and the communication device 104 is conveyed, via the communication link 112. The method at the first communication device is initiated at step 202. At step 204, the first communication device requests a third communication device of the plurality of communication devices to associate with the communication session, via a second communication link. Examples of the third communication device include, but are not limited to, mobile phones, landline phones, computers, web servers, Internet servers, voice-messaging systems, audio-broadcast systems, video-broadcast systems, and conferencing systems. Examples of the second communication link include a short-range communication channel, and a short messaging service. For example, the communication device 104 can request the communication device 108 to be associated with the communication session, via the communication link 114.

At step 206, it is determined whether the communication session can be associated with the third communication device. The determination at step 206 is substantially independent of the service-provider server. For example, the communication device 104 determines whether it can associate the communication session with the communication device 108, through a Bluetooth™ connection. If it is determined at step 206 that the communication session can be associated with the third communication device, then step 208 is performed. At step 208, the first communication device requests the service-provider server to associate the communication session with the third communication device. For example, the communication device 104 can request the service-provider server 102 to associate the communication session with the communication device 108. The service-provider server associates the communication session with the third communication device, via a third communication link. For example, the service-provider server 102 can associate the communication device 108 via the communication link 116. The method at the first communication device is terminated at step 210.

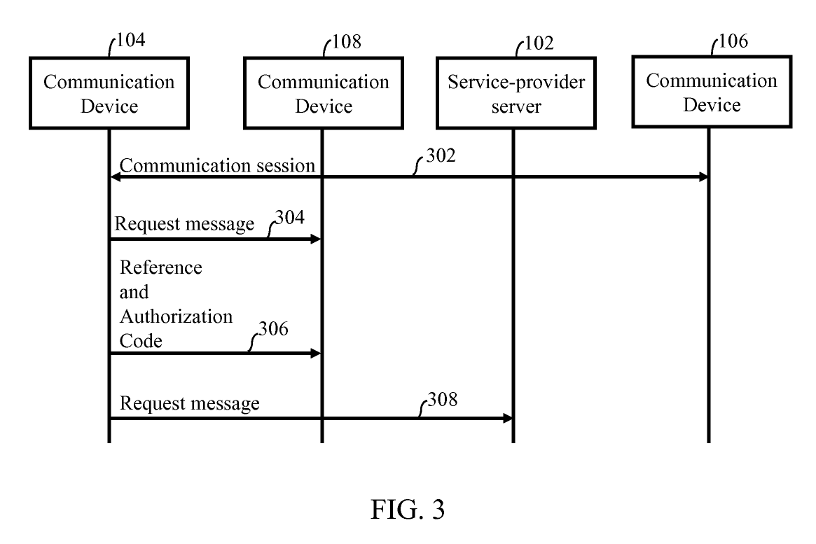

FIG. 3 is a message flow diagram illustrating a method for managing a communication session, in accordance with one embodiment of the present invention. The following method will be explained in conjunction with a first communication device, a second communication device, a third communication device, and a service-provider server. The communication session between the first communication device and the service-provider server is conveyed, via a first communication link. For example, the communication device 104 can communicate with the service-provider server 102, via the communication link 112. The communication session is managed between the first communication device and the second communication device. For example, a communication session 302 is managed between the communication device 104 and the communication device 106. The first communication device can detect the presence of one or more communication devices of the plurality of communication devices, via a second communication link. For example, the communication device 104 can detect the communication devices 108 and 110, via a Bluetooth™ connection. Further, the first communication device can select a third communication device from the plurality of communication devices. For example, the communication device 104 can select the communication device 108. For one embodiment, information of the third communication device can be displayed at the first communication device. Information of the third communication device can include, but is not limited to, the name of a user associated with the third communication device, physical location of the third communication device, Internet Protocol (IP) address of the third communication device, phone number of the third communication device, capabilities of the third communication device, applications supported by the third communication device, and preferences of the third communication device. The first communication device or a user of the first communication device can use this information to determine whether the communication session can, be associated with the third communication device. The first communication device then determines whether the communication session can be associated with the third communication device. For example, the communication device 104 can use information of the communication device 108 to determine that the communication session 302 can be associated with the communication device 108. For one embodiment, the determination is based on, for example, a response from the third communication device, a user input, a predetermined policy, a type of communication device, a type of communication session, the capability of either the first communication device or the third communication device, a user authorization, the type of communication network, the time of the day, the geographical location, the availability of a communication resource, and the quality of the service level.

Thereafter, the first communication device requests the third communication device of the plurality of communication devices to associate with the communication session, via a second communication link. For example, the communication device 104 can send a request message 304 to the communication device 108, via the communication link 114. The first communication device, after successfully negotiating with the third communication device, can provide a reference of the communication session to the third communication device, via the second communication link. For example, the communication device 104, after successfully negotiating with the communication device 108, can provide the reference of the communication session 302, via a message 306 to the communication device 108. For one embodiment, the first communication device generates an authorization code. This authorization code is used to associate the communication session securely with the third communication device. The first communication device then provides the authorization code to the third communication device. For example, the communication device 104, after generating the authorization code, can provide the authorization code to the communication device 108, via the message 306. Thereafter, the first communication device can request the service-provider server to associate the communication session with the third communication device. For example, the communication device 104 can send a request message 308 to the service-provider server 102. The request message 308 can include the authorization code. Information about the communication session can also be conveyed in the request message 308 to assist with a subsequent acquisition and decoding of the communication session. Examples of the information include, but are not limited to, a position in a file, a web page number, a position in a video stream, a data rate of the communication session, an encoding rate of the communication session, object information, a decoder state, a game scenario being played, and characteristics of a game.

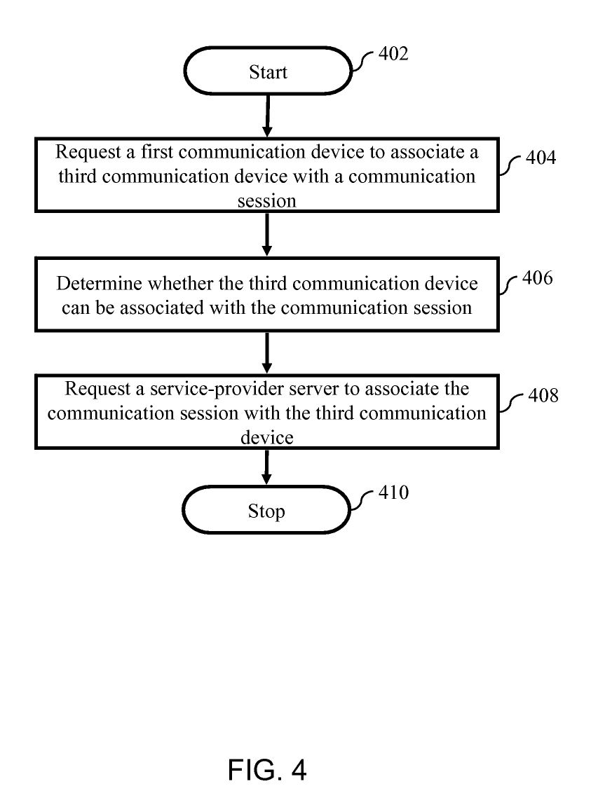

FIG. 4 is a flow diagram illustrating a method for managing a communication session, in accordance with another embodiment of the present invention. The communication session is managed between a first communication device and a second communication device. The communication session between the first communication device and the service-provider server can be conveyed, via a first communication link. The method at a third communication device is initiated at step 402. At step 404, the third communication device of the plurality of communication devices requests the first communication device to associate the third communication device with the communication session, via a second communication link. For example, the communication device 108 can request the communication device 104, via the communication link 114, to associate the communication device 108 with the communication session.

At step 406, it is determined whether the third communication device can associate with the communication session. If it is determined at step 406 that the third communication device can associate with the communication session, step 408 is performed. At step 408, the third communication device requests the service-provider server to associate the communication session with the third communication device. For example, the communication device 108 can request the service-provider server 102 to associate the communication session with the communication device 108. The service-provider server associates the communication session with the third communication device via a third communication link. For example, the service-provider server 102 can associate the communication session with the communication device 108, via the communication link 116. The method at the third communication device is terminated at step 410.

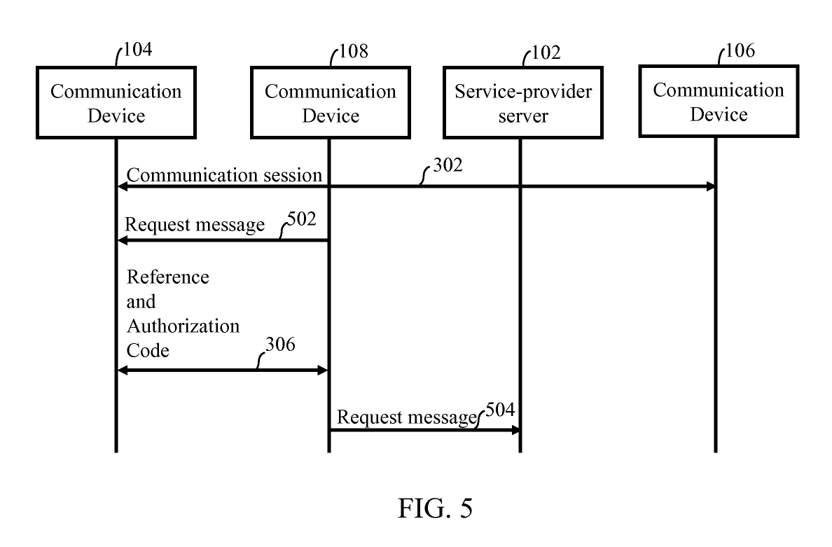

FIG. 5 is a message flow diagram illustrating a method for managing a communication session, in accordance with another embodiment of the present invention. The following method will be explained in conjunction with a first communication device, a second communication device, a third communication device, and a service-provider server. The communication session between the first communication device and the service-provider server is conveyed, via a first communication link. For example, the communication device 104 can communicate with the service-provider server 102, via the communication link 112. The communication session is managed between the first communication device and the second communication device. For example, the communication session 302 is managed between the communication device 104 and the communication device 106. A third communication device can request the first communication device, via a second communication link, to associate the third communication device with the communication session. For example, the communication device 108 can send a request message 502 to the communication device 104 to associate the communication device 108 with the communication session 302. The third communication device then determines whether it should associate with the communication session. For one embodiment, this determination is based on, for example, a response from the first communication device, a user input, a predetermined policy, the type of communication device, the type of communication session, the capability of either the first communication device or the third communication device, user authorization, the type of communication network, the time of the day, the geographical location, the availability of a communication resource, and the quality of service level. After successfully negotiating with the first communication device, the third communication device receives a reference of the communication session from the first communication device, via the second communication link. For example, the communication device 108, after successfully negotiating with the communication device 104, can receive the reference of the communication session 302 from the communication device 104. For one embodiment, the third communication device can also receive an authorization code from the first communication device, via the second communication link. For example, the communication device 108 can receive the authorization code from the communication device 104, via a message 306. For another embodiment of the present invention, the communication device 108 can further receive information of the communication session from the communication device 104. Examples of the information of the communication session include, but are not limited to, a position in a file, a web page number, a position in a videos stream, a data rate of the communication session, object information, an encoding rate of the communication session, a decoder state, a game scenario being played, and characteristic of a game. The third communication device then requests the service-provider server to associate the communication session with the third communication device. For example, the communication device 108 can send a request message 504 to the service-provider server 102 to associate communication session 302 with it. The third communication device also provides the authorization code and the reference of the communication session to the third communication device. The communication session is associated with the third communication device via a third communication link. For example, the communication session can be associated with the communication device 108, via the communication link 116.

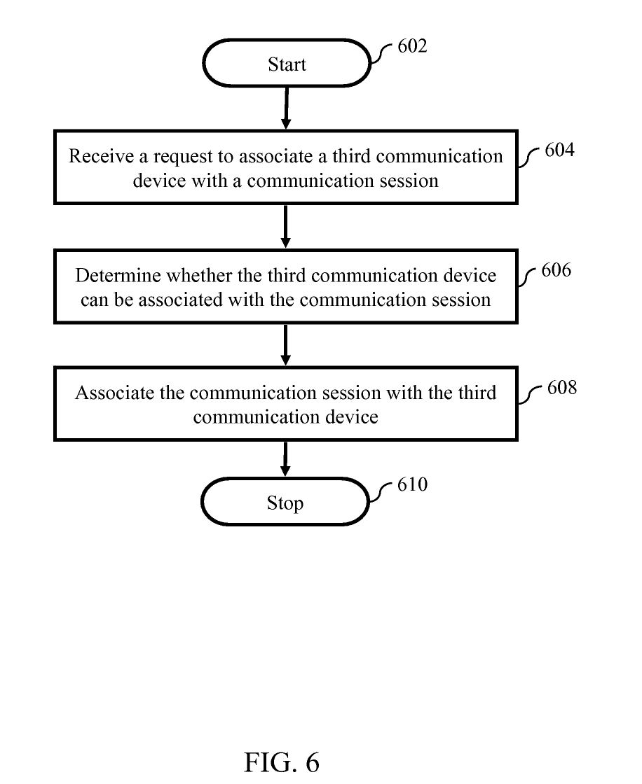

FIG. 6 is a flow diagram illustrating a method for managing a communication session, in accordance with yet another embodiment of the present invention. The communication session is managed between a first communication device and a second communication device. The communication session between the first communication device and a service-provider server can be conveyed, via a first communication link. The method at the service-provider server is initiated at step 602. At step 604, the service-provider server receives a request from at least one of the first communication device and a third communication device to associate the third communication device with the communication session. For example, either the communication device 104 or the communication device 108 can request the service-provider server 102 to associate the communication device 108 with the communication session 302.

At step 606 the service-provider server determines whether the third communication device can be associated with the communication session. For example, the service-provider server 102 can determine whether the communication device 108 can be associated with the communication session 302. At step 608, the service-provider server associates the communication session with the third communication device, via a third communication link. For example, the service-provider server 102 can associate the communication session 302 with the communication device 108, via the communication link 116.

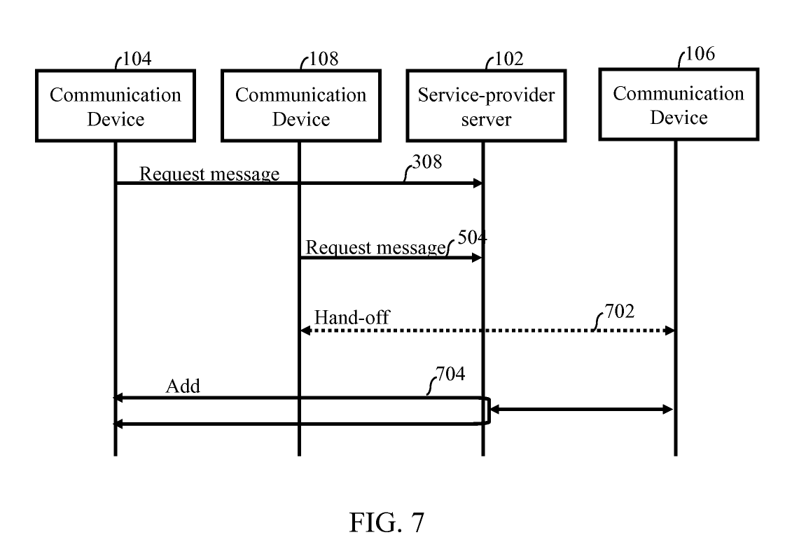

FIG. 7 is a message flow diagram illustrating a method for managing a communication session, in accordance with yet another embodiment of the present invention. The following method will be explained in conjunction with a first communication device, a second communication device, a third communication device, and a service-provider server. The communication session between the first communication device and the service-provider server is provided, via a first communication link. For example, the communication device 104 can communicate with the service-provider server 102, via the communication link 112. The communication session is managed between the first communication device and the second communication device. For example, the communication session can be managed between the communication devices 104 and 106. The service-provider server receives a request from one of the first communication device and the third communication device to associate the third communication device with the communication session. For example, the service-provider server 102 can either receive the request message 308 from the communication device 104 or the request message 504 from the communication device 108. For one embodiment, the service-provider server also receives a reference of the communication session and an authorization code from the third communication device. For example, the service-provider server 102 can receive the reference of the communication session 302 and the authorization code from the communication device 108. For another embodiment, the service-provider server receives the authorization code from the first communication device. For example, the service-provider server 102 can receive the authorization code from the communication device 104. For one embodiment, the service-provider server correlates the authorization code received from the communication device 104 and the communication device 108. Further, the service-provider server correlates the reference of the communication session 302 received from the communication device 108 and the reference of the communication session stored at the service-provider server 102. The service-provider server can either hand off the communication session from the first communication device to the third communication device, or add the third communication device to the communication session. For example, the service-provider server 102 can hand off the communication session 302 to the communication device 108 via a message 702. The service-provider server 102 can add the communication device 108 to the communication session 302 via a message 704.

Various embodiments, as described above, provide a method for managing a communication session in a communication network. The present invention provides a method for seamlessly handing off a communication session to a communication device. The present invention also provides a method for adding the communication device to the communication session, without placing the communication session on hold. Various embodiments also provide a secure way of handing off the communication session, or adding a communication device to the communication session. Further, various embodiments does not require a pre-stored or manual entry of identification of a communication device to which the communication session is to be associated.

In the foregoing specification, the invention and its benefits and advantages have been described with reference to specific embodiments. However, one of ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all of the claims. The invention is defined solely by the appended claims, including any amendments made during the pendency of this application and all equivalents of those claims as issued.

What is claimed is:

1. A method for managing a communication session between a first communication device and a second communication device in a communication network, the communication network comprising a plurality of communication devices and one or more service-provider servers, the communication session being conveyed between the first communication device and a service-provider server of the one or more service-provider servers, via a first communication link, the method at the first communication device of the plurality of communication devices comprising:
requesting a third communication device of the plurality of communication devices to be associated with the communication session, via a second communication link, wherein the second communication link is substantially transparent to the service-provider server;
determining if the communication session can be associated with the third communication device; and
requesting the service-provider server to associate the communication session with the third communication device when the third communication device can be associated with the communication session, wherein the third communication device is associated with the communication session, via a third communication link.

2. The method as recited in claim 1, wherein determining is based on at least one of a response from the third communication device, a user input, a predetermined policy, a type of a communication device, a type of the communication session, capability of the first communication device, capability of the third communication device, a user authorization, a type of the communication network, a time of a day, a geographical location, availability of a communication resource and a quality of service level.

3. The method as recited in claim 1 further comprising:
detecting a one or more communication devices of the plurality of communication devices, via the second communication link; and
selecting the third communication device of the one or more communication devices.

4. The method as recited in claim 1 further comprising displaying information of the third communication device.

5. The method as recited in claim 1, wherein determining further comprises successfully negotiating with the third communication device.

6. The method as recited in claim 1 further comprising providing a reference of the communication session to the third communication device, via the second communication link.

7. The method as recited in claim 1 further comprising:
generating an authorization code, wherein the authorization code is used for securely associating the communication session with the third communication device;
providing the authorization code to the third communication device, via the second communication link; and
providing the authorization code to the service-provider server.

8. The method as recited in claim 1 further comprising providing information of the communication session, wherein the information of the communication session is selected from a group comprising a position in a file, a web page number, a position in a videos stream, a data rate of the communication session, object information, an encoding rate of the communication session, a decoder state, a game scenario being played, and characteristics of a game.

9. The method as recited in claim 1, wherein the second communication link is selected from a group comprising an infrared communication link, a Universal Serial Bus (USB) communication link, a Bluetooth™ communication link, and a Wireless Fidelity (WiFi) communication link.

10. The method as recited in claim 1, wherein the communication session comprises at least one of a voice call, a voice over Internet Protocol (IP) call, a video call, a push-to-talk session, a data session, an Internet session, a file download, a web-browsing session, a net-meeting session, a group dispatch session, a voice conference call and a video conference.

11. A method for managing a communication session between a first communication device and a second communication device in a communication network, the communication network comprising a plurality of communication devices and one or more service-provider servers, the communication session being conveyed between the first communication device, and a service-provider server of the one or more service-provider servers, via a first communication link, the method at a third communication device of the plurality of communication devices comprising:
requesting the first communication device to associate the third communication device with the communication session, via a second communication link, wherein the second communication link is substantially transparent to the service-provider server;
determining if the third communication device can be associated with the communication session; and
requesting the service-provider server to associate the communication session with the third communication device when the third communication device can be associated with the communication session, wherein the third communication device is associated with the communication session, via a third communication link.

12. The method as recited in claim 11, wherein determining further comprises successfully negotiating with the first communication device.

13. The method as recited in claim 11 further comprising:
receiving a reference of the communication session from the first communication device, via the second communication link; and
providing the reference of the communication session to the service-provider server.

14. The method as recited in claim 11 further comprising:
receiving an authorization code from the first communication device, via the second communication link, wherein the authorization code is used for securely associating the communication session with the third communication device; and
providing the authorization code to the service-provider server.

15. The method as recited in claim 11 further comprising receiving information of the communication session, wherein the information of the communication session is selected from a group comprising a position in a file, a web page number, a position in a videos stream, a data rate of the communication session, object information, an encoding rate of the communication session, a decoder state, a game scenario being played, and characteristic of a game.

16. A method for managing a communication session between a first communication device and a second communication device in a communication network, the communication network comprising a plurality of communication devices and one or more service-provider servers, the communication session being conveyed between the first communication device, and a service-provider server of the one or more service-provider servers, via a first communication link, the method at the service-provider server of the one or more service-provider servers comprising:
receiving a request to associate a third communication device of the plurality of communication devices with the communication session, wherein the first communication device communicates with the third communication device, via a second communication link, wherein the second communication link is substantially transparent to the service-provider server;
determining if the third communication device can be associated with the communication session; and
associating the communication session with the third communication device when the third communication device can be associated with the communication session, via a third communication link.

17. The method as recited in claim 16, wherein the request is received from one of the first communication device and the third communication device.

18. The method as recited in claim 16 further comprising:
receiving a reference of the communication session from the third communication device;
receiving an authorization code from the first communication device; and
receiving the authorization code from the third communication device, wherein the authorization code is used for securely associating the communication session with the third communication device.

19. The method as recited in claim 18 further comprising correlating the authorization code received from the first communication device and the authorization code received from the third communication device.

20. The method as recited in claim 18 further comprising correlating the reference of the communication session received from the third communication device and the reference of the communication session stored at the service-provider server.

21. The method as recited in claim 16, wherein associating the communication session comprises one of handing off the communication session from the first communication device to the third communication device and adding the third communication device to the communication session.
